(19) United States
(12) Patent Application Publication
(10) Pub. No.: US 2026/0279953 A1
(43) Pub. Date: Sep. 17, 2026

(54) BATTERY PACK AND DRONE

(71) Applicant: MEITUAN TECHNOLOGY CO., LTD., Shenzhen (CN)

(72) Inventors: Aodi ZHENG, Shenzhen (CN); Yeming XU, Shenzhen (CN); Han GAO, Shenzhen (CN); Peidong CHEN, Shenzhen (CN); Yulei PANG, Shenzhen (CN); Peng FU, Shenzhen (CN); Lijun XU, Shenzhen (CN); Haotian WU, Shenzhen (CN)

(73) Assignee: MEITUAN TECHNOLOGY CO., LTD., Shenzhen (CN)

(21) Appl. No.: 19/307,665

(22) Filed: Aug. 22, 2025

(30) Foreign Application Priority Data
Mar. 12, 2025 (CN) 202510293147.2

(51) Int. Cl. H01M 10/6551; B64U 50/30; H01M 10/613; H01M 10/625; H01M 10/647; H01M 10/653; H01M 10/6554; H01M 50/209; H01M 50/249

(52) U.S. Cl. CPC H01M 10/6551; B64U 50/30; H01M 10/613; H01M 10/625; H01M 10/647; H01M 10/653; H01M 10/6554; H01M 50/209; H01M 50/249; H01M 2220/20

(57) ABSTRACT

A battery pack and a drone, the battery pack includes a housing, an electrochemical cell, and a heat dissipation assembly. Each of the electrochemical cells has a first side surface and a second side surface that are adjacent. Two adjacent electrochemical cells are disposed opposite to each other by using first side surfaces. The heat dissipation assembly includes a heat conduction member. The heat conduction member includes a first heat conduction body and a second heat conduction body. The first heat conduction body is disposed between the two adjacent electrochemical cells, and separately comes into heat conduction contact with the first side surfaces of the two electrochemical cells. The second heat conduction body is disposed at an angle to the first heat conduction body. The second heat conduction body extend along the second side surface, and come into heat conduction contact with the housing.

### CROSS REFERENCE TO RELATED APPLICATION

The present application claims priority to the Chinese Patent Application No. 202510293147.2, filed on Mar. 12, 2025. The entire contents of the above-listed application are hereby incorporated by reference for all purposes.

### BACKGROUND

After a drone flies for a long time or violently (rapidly or frequently changes a flight status), because a battery cannot effectively dissipate heat, a temperature of an electrochemical cell inside the battery increases. A continuously high temperature reduces a life of the battery, reduces a working effect of the battery, and leads to a low heat dissipation speed. In addition, the battery cannot be charged due to the high temperature, thereby increasing a time period for subsequently charging the battery. Therefore, a person skilled in the art needs to urgently resolve a problem of rapid heat dissipation of the battery of the drone.

### SUMMARY

The present disclosure relates to the field of drone technologies, and specifically, to a battery pack and a drone to which the battery pack is applied.

An objective of the present disclosure is to provide a battery pack. The battery pack has a good heat dissipation effect and relatively high working efficiency.

To achieve the foregoing objective, a first aspect of the present disclosure provides a battery pack, including: a housing; an electrochemical cell, the electrochemical cell being disposed inside the housing and a plurality of electrochemical cells being disposed along a first direction; and each of the electrochemical cells having a first side surface and a second side surface that are adjacent to each other, and the first side surface being disposed perpendicular to the first direction; and a heat dissipation assembly, the heat dissipation assembly including a heat conduction member, the heat conduction member including a first heat conduction body and a second heat conduction body, the first heat conduction body being disposed between adjacent electrochemical cells and separately coming into heat conduction contact with first side surfaces of the two adjacent electrochemical cells, the second heat conduction body being disposed at an angle to the first heat conduction body, and the first heat conduction body and the second heat conduction body extending along the second side surface, and coming into heat conduction contact with the housing.

Optionally, the heat conduction member includes at least a pair of a first heat conduction body and a second heat conduction body that are adjacent to each other; and a plurality of heat conduction members are disposed along the first direction, each of the heat conduction members includes two first heat conduction bodies and one second heat conduction body connected between the two first heat conduction bodies, or the heat conduction member is single and includes a plurality of first heat conduction bodies and a plurality of second heat conduction bodies that are alternately disposed along the first direction, and two adjacent second heat conduction bodies are respectively connected on two side edges of a same first heat conduction body.

Optionally, the heat conduction member is of a sheet-like structure, and the sheet-like structure is a graphitic sheet or a graphene sheet.

Optionally, the heat dissipation assembly further includes a heat conduction pad, the heat conduction pad includes a first heat conduction pad, the first heat conduction pad is disposed between the second heat conduction body and the second side surface of the electrochemical cell, a plurality of first heat conduction pads are disposed along the first direction, and/or the heat conduction pad further includes a second heat conduction pad, the second heat conduction pad is disposed between the second heat conduction body and the housing, and the second heat conduction pad covers at least two second heat conduction bodies along the first direction.

Optionally, the heat conduction pad is a graphite foam, the heat conduction pad further includes a third heat conduction pad, and the third heat conduction pad is disposed between the electrochemical cell and the housing, and/or is disposed between the adjacent electrochemical cells.

Optionally, the battery pack further includes a heating member, and the heating member is configured to heat the plurality of electrochemical cells.

Optionally, the heating member is constructed as a heating film surrounding the electrochemical cell, an avoidance hole is provided on the heating film, and the avoidance hole is used for exposing the second heat conduction body.

Optionally, the heating member is constructed as an S-shaped heating film that sequentially surrounds the plurality of electrochemical cells, a plurality of heat conduction members are disposed along the first direction, each of the heat conduction members includes two first heat conduction bodies and one second heat conduction body connected between the two first heat conduction bodies, and a plurality of avoidance holes for exposing second heat conduction bodies are provided on the heating film.

Optionally, a heat dissipation plate is disposed on a windward side of the housing, the heat dissipation plate is formed by a side wall of the housing or is installed on a side wall of the housing, an inner side of the heat dissipation plate comes into heat conduction contact with the second heat conduction body, and a heat dissipation fin is disposed on an outer side of the heat dissipation plate.

According to a second aspect of the present disclosure, a drone is further provided, including the battery pack according to the foregoing embodiments.

Compared with a related technology, advantages of the present disclosure are as follows: The battery pack in the present disclosure includes the housing, the electrochemical cell, and the heat dissipation assembly. The heat dissipation assembly is disposed between the electrochemical cells, and the heat dissipation assembly includes the first heat conduction body in heat conduction contact with the electrochemical cell and the second heat conduction body in heat conduction contact with the housing, so that heat generated by the electrochemical cell can be transferred to the housing of the battery pack through the first heat conduction body and the second heat conduction body in the heat dissipation assembly, and is then rapidly dissipated by using a temperature difference between an external environment and the housing, thereby avoiding final impact that is on use efficiency of the battery pack and a subsequent charging effect and that is caused by accumulation of the heat generated by the electrochemical cell inside the battery pack.

Other features and advantages of the present disclosure are described in detail in the following detailed implementations.

### BRIEF DESCRIPTION OF DRAWINGS

The accompanying drawings are intended to provide further understanding of the present disclosure and constitute a part of this specification. The accompanying drawings and the specific implementations below are used together for explaining the present disclosure rather than constituting a limitation on the present disclosure. In the accompanying drawings:

FIG. 1 is a schematic diagram of a structure of a battery pack according to an exemplary implementation of the present disclosure;

FIG. 2 is a schematic diagram of a structure of an electrochemical cell part in a battery pack according to an exemplary implementation of the present disclosure;

FIG. 3 is an exploded view of an electrochemical cell part in a battery pack according to an exemplary implementation of the present disclosure;

FIG. 4 is a partial enlarged view of a cross-sectional view of a battery pack according to an exemplary implementation of the present disclosure;

FIG. 5 is a schematic diagram of a structure of a battery pack according to another exemplary implementation of the present disclosure;

FIG. 6 is a schematic diagram of a structure of an electrochemical cell part in a battery pack according to another exemplary implementation of the present disclosure;

FIG. 7 is an exploded view of an electrochemical cell part in a battery pack according to another exemplary implementation of the present disclosure; and

FIG. 8 is a partial enlarged view of a cross-sectional view of a battery pack according to another exemplary implementation of the present disclosure.

### DESCRIPTIONS OF REFERENCE NUMERALS

1-HOUSING; 11-HEAT DISSIPATION PLATE;
2-heat dissipation assembly; 21-heat conduction member; 211-first heat conduction body; 212-second heat conduction body; 22-heat conduction pad; 221-first heat conduction pad; 222-second heat conduction pad; 223-third heat conduction pad;
3-electrochemical Cell; 4-heating Member; and 41-avoidance Hole.

### DETAILED DESCRIPTION

Specific implementations of the present disclosure are described in detail below with reference to the accompanying drawings. It should be understood that the specific implementations described herein are merely used to describe and explain the present disclosure, but are not intended to limit the present disclosure.

In the present disclosure, unless otherwise stated, directional words such as “upper, lower, high, low, top, and bottom” generally refer to a position of a corresponding component or structure in a gravity direction. “Inner and outer” refer to inner and outer contours of a corresponding component. In addition, it should be noted that the used terms such as “first” and “second” are used to distinguish one element from another element, and have no sequence and importance. In addition, in the descriptions with reference to the accompanying drawings, a same sign in different accompanying drawings represent a same element. The foregoing definitions are merely used to explain and describe the present disclosure, and should not be understood as a limitation on the present disclosure.

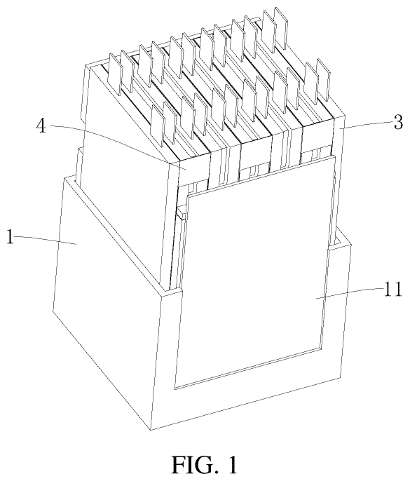

For ease of understanding, the following describes a specific structure and the working principle of a battery pack in the present disclosure in detail in combination with embodiments with reference to FIG. 1 to FIG. 8.

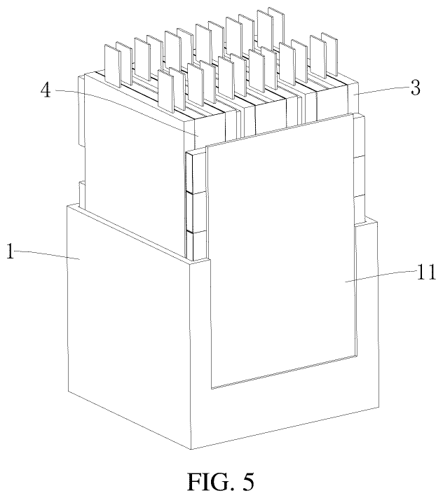

The present disclosure relates to a battery pack that can effectively dissipate heat, thereby avoiding problems of low working efficiency and relatively slow charging that are caused by an excessively high temperature of the battery pack. As shown in FIG. 1 and FIG. 5, the battery pack in the present disclosure includes a housing 1, a heat dissipation assembly 2, and an electrochemical cell 3. The housing 1 may be made of a metal material and has relatively good strength. An inner cavity may be formed in the housing 1, for installing and placing the heat dissipation assembly 2 and the electrochemical cell 3. The electrochemical cell 3 is disposed in the housing 1. A plurality of electrochemical cells are disposed along a first direction. Each of the electrochemical cells 3 has a first side surface and a second side surface that are adjacent to each other. The first side surface is perpendicular to the first direction. For example, the electrochemical cell 3 may be square, and the square electrochemical cell 3 has two first side surfaces and two second side surfaces that are adjacent. During installation, first side surfaces of two adjacent electrochemical cells 3 are disposed opposite to each other. Certainly, in another embodiment, the electrochemical cell 3 may alternatively be of another shape, provided that the electrochemical cell 3 can have a first side surface and a second side surface that are adjacent to each other, and the first side surface of the electrochemical cell 3 is perpendicular to the first direction. A specific shape may be determined depending on an actual situation, and this is not limited in the present disclosure.

The heat dissipation assembly 2 includes a heat conduction member 21. The heat conduction member 21 includes a first heat conduction body 211 and a second heat conduction body 212. The first heat conduction body 211 is disposed between the adjacent electrochemical cells 3 and separately comes into heat conduction contact with the first side surfaces of the two adjacent electrochemical cells. The second heat conduction body 212 is disposed at an angle to the first heat conduction body 211. The first heat conduction body and the second heat conduction body extend along the second side surface of the electrochemical cell 3, and come into heat conduction contact with the housing 1. It should be noted that, the heat conduction contact may be that the first heat conduction body 211 and the second heat conduction body 212 come into direct contact with the first side surface of the electrochemical cell 3 and the housing 1 for heat transfer. Alternatively, another heat conduction material may be disposed between the first heat conduction body 211 and the first side surface of the electrochemical cell 3, and between the second heat conduction body 212 and the housing 1, so that the first heat conduction body 211 and the second heat conduction body 212 come into indirect contact with the first side surface of the electrochemical cell 3 and the housing 1 for heat transfer. Alternatively, another contact manner that can be used for heat transfer is used. Details are not described herein again.

During use of the battery pack, because the first heat conduction body 211 comes into heat conduction contact with the first side surface of the electrochemical cell 3, heat generated by the electrochemical cell 3 is transferred to the first heat conduction body 211. Then, because the first heat conduction body 211 is connected to the second heat conduction body 212, the heat in the first heat conduction body 211 continues to be transferred to the second heat conduction body 212 along the first heat conduction body 211, finally is transferred to the housing 1 through the second heat conduction body 212, and is dissipated to an external environment. Based on the battery pack in the present disclosure, the heat dissipation assembly 2 is disposed between the electrochemical cells 3, so that heat generated by the electrochemical cell can be transferred to the housing 1 of the battery pack through the first heat conduction body 211 and the second heat conduction body 212 that are in the heat conduction member 21, and is then rapidly dissipated by using a temperature difference between the external environment and the housing 1, thereby avoiding final impact that is on use efficiency of the battery pack and a subsequent charging effect and that is caused by accumulation of the heat generated by the electrochemical cell 3 inside the battery pack.

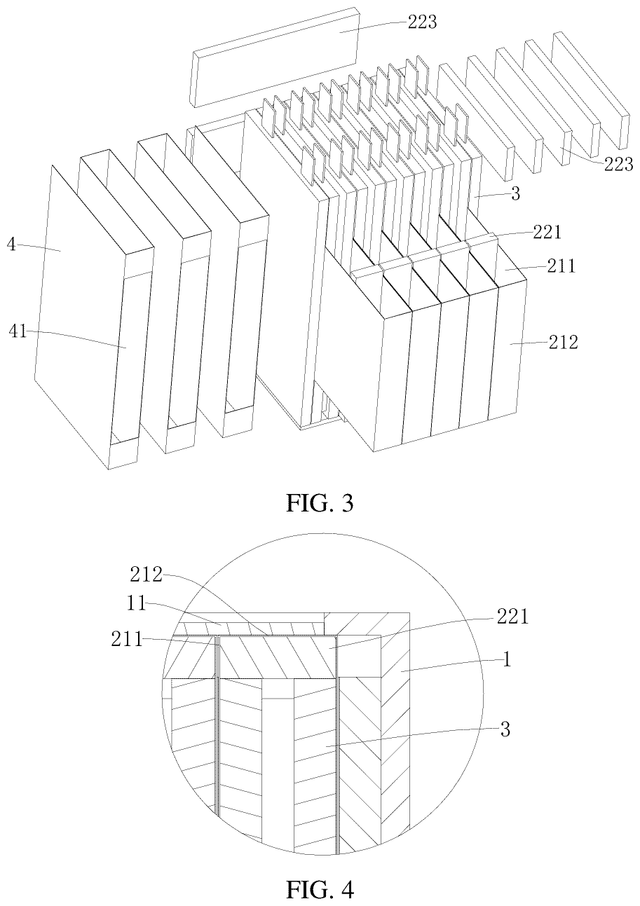

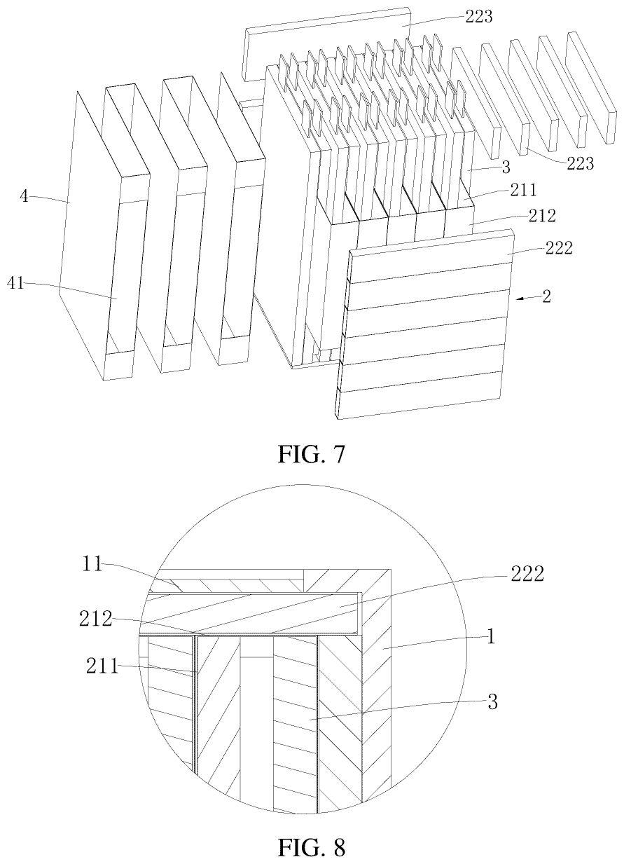

In an embodiment of the present disclosure, as shown in FIG. 3 and FIG. 7, a plurality of heat conduction members 21 are disposed along the first direction, and are distributed between a plurality of electrochemical cells 3. The heat conduction member 21 includes at least a pair of a first heat conduction body 211 and a second heat conduction body 212 that are adjacent to each other, to form an L-shaped heat conduction member 21, so that when the disposition is completed, at least one first heat conduction body 211 is located between the first side surfaces of the two adjacent electrochemical cells 3, and at least one second heat conduction body 212 is located between the second side surface of the electrochemical cell 3 and the housing 1.

Certainly, in another embodiment, the heat conduction member 21 may further have a plurality of forms. For example, the heat conduction member 21 may include two first heat conduction bodies 211 and one second heat conduction body 212 connected between the two first heat conduction bodies 211, to form a C-shaped heat conduction member 21. During deposition, the two first heat conduction bodies 211 are disposed between the two adjacent electrochemical cells 3, to better transfer heat generated by the electrochemical cell 3 in a working process.

In another embodiment, only one heat conduction member 21 may alternatively be disposed. The single heat conduction member 21 includes a plurality of first heat conduction bodies 211 and a plurality of second heat conduction bodies 212 that are alternately disposed along the first direction. Two adjacent second heat conduction bodies 212 are respectively connected on two side edges of a same first heat conduction body 211. Alternatively, the single heat conduction member 21 is disposed around the electrochemical cell 3 in an S shape, so that during installation, the single heat conduction member 21 can be directly installed between a plurality of electrochemical cells 3, to rapidly and conveniently complete the installation. Certainly, the heat conduction member 21 may alternatively have another shape, provided that heat generated between the electrochemical cells 3 can be conducted to the housing 1 for dissipation. Details may be specifically determined depending on an actual situation. This is not limited in the present disclosure.

In an embodiment of the present disclosure, the heat conduction member 21 is of a sheet-like structure, and the sheet-like structure is a graphitic sheet or a graphene sheet. The heat conduction member 21 of the sheet-like structure facilitates increasing a contact area between the heat conduction member 21 and the electrochemical cell 3, thereby enabling a fitting area between the heat conduction member 21 and the electrochemical cell 3 to be larger, and fitting to be closer to facilitate heat conduction. The graphitic sheet and the graphene sheet have relatively good strength and a relatively good heat conduction effect, and the graphene sheet further includes a graphene heat conduction film having a larger thickness. A total thickness of a multi-layer structure (approximately dozens to hundreds of layers) may be as high as 500 microns to 1 millimeter, and the multi-layer structure has better heat conduction effect. Therefore, using the graphite sheet or the graphene sheet to make the heat conduction member 21 can enable a heat dissipation effect of the heat dissipation assembly 2 to be better, accelerate heat dissipation efficiency of the battery pack, and enable the battery pack to have higher use efficiency.

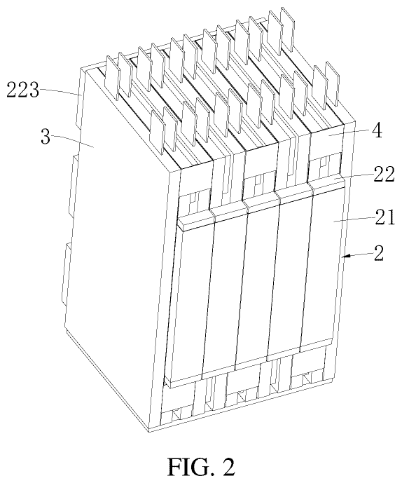

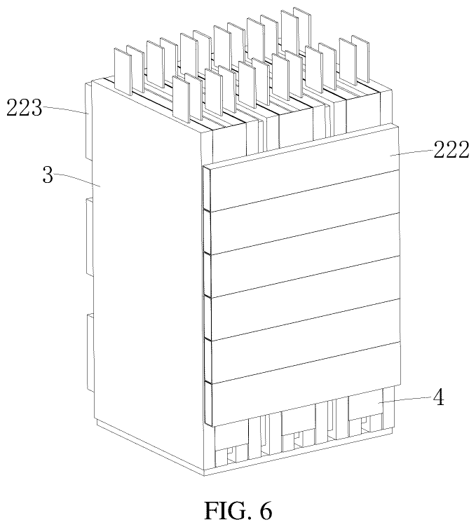

In an embodiment of the present disclosure, as shown in FIG. 2 and FIG. 6, the heat dissipation assembly 2 further includes a heat conduction pad 22. During flight of a drone, because a flight speed is relatively high and a flight direction is variable, if the heat conduction pad 22 is not disposed, the electrochemical cell 3 comes into direct contact with and collides with and the housing 1, thereby causing damage to the electrochemical cell 3 and the second heat conduction body 212.

In some embodiments, as shown in FIG. 2 and FIG. 4, the heat conduction pad 22 includes a first heat conduction pad 221, the first heat conduction pad 221 is disposed between the second heat conduction body 212 and the second side surface of the electrochemical cell 3, and a plurality of first heat conduction pads 221 are disposed along the first direction. A quantity of first heat conduction pads is consistent with a quantity of heat conduction members 21, to ensure that there is a first heat conduction pad 221 between each second heat conduction body 212 and the second side surface of the electrochemical cell 3. The first heat conduction pad 221 is located between the second heat conduction body 212 and the second side surface of the electrochemical cell 3. The first heat conduction pad 221 may play a role in protecting the electrochemical cell 3 and the second heat conduction body 212. In addition, after heat is conducted to the second heat conduction body 212 through the first heat conduction body 211, the second heat conduction body 212 may directly come into contact with the housing 1 for heat dissipation, thereby achieving higher heat conduction efficiency.

In some other embodiments, as shown in FIG. 6 and FIG. 8, the heat conduction pad 22 includes a second heat conduction pad 222. The second heat conduction pad 222 is disposed between the second heat conduction body 212 and the housing 1, so that heat in the second heat conduction body 212 may be conducted to the housing 1 through the second heat conduction pad 222 for heat dissipation. In addition, the second heat conduction pad 222 covers at least two second heat conduction bodies 212 along the first direction. The second heat conduction pad 222 may cover all the second heat conduction bodies 212 along the first direction, to reduce a temperature difference between the electrochemical cells 3 and maintain stability during working of the electrochemical cell 3. In addition, the second heat conduction pad 222 may be an integral heat conduction pad 22 that is not easily separated, to ensure a protection effect on the electrochemical cell 3, or may be made of a plurality of sub-bodies that are disposed in parallel along a second direction perpendicular to the first direction. Disposing the plurality of sub-bodies may establish a plurality of hot runners in indirect gaps between different sub-bodies, so that heat can be better conducted to the housing 1 along a thickness direction of the second heat conduction pad 222 for better heat dissipation. Certainly, in another embodiment, a shape and distribution of the heat conduction pad 22 may alternatively be of another type, and may be specifically determined depending on an actual situation. This not limited in the present disclosure.

In an embodiment of the present disclosure, as shown in FIG. 3 and FIG. 7, the heat conduction pad 22 further includes a third heat conduction pad 223. The third heat conduction pad 223 is disposed between the electrochemical cell 3 and the housing 1. A plurality of third heat conduction pads 223 are respectively located on various side surfaces of the electrochemical cell 3, to play a role of supporting, fixing, buffering, and shock absorbing to prevent squeezing and a collision between the electrochemical cell 3 and the housing 1. A square electrochemical cell 3 is used as an example. The third heat conduction pads 223 may be located on four side surfaces of the electrochemical cell. The third heat conduction pad 223 may further be disposed between adjacent electrochemical cells 3, to avoid squeezing and a collision between the adjacent electrochemical cells 3, and may further play a role of fixing the electrochemical cell and preventing deformation and expansion of the electrochemical cell. It should be noted that, depending on an actual situation, the third heat conduction pad 223 may be disposed only between the electrochemical cell 3 and the housing 1 and only between the adjacent electrochemical cells 3, or between the electrochemical cell 3 and the housing 1 and between the adjacent electrochemical cells 3. This is not limited in the present disclosure.

In an embodiment of the present disclosure, the heat conduction pad 22 is made of a graphite foam. The graphite foam has excellent heat conduction performance, can transmit heat effectively, has relatively high strength and endurance, can be stable in various environments, and may further be customized in cross section and cut in length according to requirements. Installation manners are simple and diverse, and are suitable for various assembly manners such as pasting and slotting, so that the heat conduction pad 22 can adapt to electrochemical cells 3 of more types and shapes. Certainly, in another embodiment, the heat conduction pad 22 may alternatively be made of another material known by a person skilled in the art, and details are not described herein again.

In an embodiment of the present disclosure, as shown in FIG. 3 and FIG. 7, a heating member 4 is further disposed in the battery pack. The plurality of electrochemical cells 3 may be heated by disposing the heating member 4, so that the battery pack in the present disclosure can heat the electrochemical cell 3 at a low temperature before charging, and the battery pack can be started up at the low temperature and perform charging after reaching a suitable temperature, thereby ensuring a charging effect.

In an embodiment of the present disclosure, as shown in FIG. 3 and FIG. 7, the heating member 4 is a heating film surrounding a plurality of electrochemical cells 3, so that a contact area between the heating film and the electrochemical cell 3 is relatively large, and a heating effect is ensured. An avoidance hole 41 is further provided on the heating film. By means of the avoidance hole 41, the heating film can be prevented from blocking heat conduction contact between the second heat conduction body 212 and the housing 1, thereby affecting heat transfer, and causing a risk of a poor heat dissipation effect in the battery pack. In addition, the heating film is disposed in a winding manner, so that assembly is relatively easily performed during processing and assembly of the battery pack. During assembly, the electrochemical cell 3 may be first inserted into a fixture, and then a heat conduction sheet 21 is fitted onto the electrochemical cell 3. Then, the heating film is wound, and the heat conduction sheet 21 is fitted. In this way, processing and assembly are performed repeatedly.

In some embodiments of the present disclosure, the heating film may be sequentially disposed around the plurality of electrochemical cells 3 in an S shape, to further ensure a contact area between the heating film and the electrochemical cell 3 and a heating effect. An example in which a plurality of heat conduction members 21 are disposed between a plurality of electrochemical cells 3 along a first direction, and are of a C shape is used. The heat conduction member 21 includes a first heat conduction body 211 disposed between first side surfaces of two electrochemical cells 3, and a second heat conduction body 212 that is located on a second side surface of the electrochemical cell 3 and that is connected between two first heat conduction bodies 211. Avoidance holes 41 on the heating film may be a plurality of rectangular openings corresponding to second heat conduction bodies 212, to ensure that the second heat conduction bodies 212 can be fully exposed, and ensure that heat conduction contact between the second heat conduction body 212 and the housing 1 is not affected.

In an embodiment of the present disclosure, as shown in FIG. 1 and FIG. 5, a heat dissipation plate 11 is disposed on a windward side of the battery pack. The heat dissipation plate 11 may be directly formed by a side wall of the housing 1. For example, another material is disposed on the housing 1, to form the heat dissipation plate 11. Alternatively, the heat dissipation plate 11 is directly installed on the housing 1 again. An inner side of the heat dissipation plate 11 comes into contact with the second heat conduction body 212 in the housing 1, and an outer side is the windward side. During flight of a drone, an air velocity on a windward side of the drone is fast, so that a heat exchange can be performed more rapidly. Heat on the heat dissipation plate 11 is carried away through air flow, to complete heat dissipation on the second heat conduction body 212 and the electrochemical cell 3 more rapidly. In another embodiment, a heat dissipation fin is further disposed on the heat dissipation plate 11. The heat dissipation fin is disposed, so that heat dissipation efficiency of the heat dissipation plate 11 can be further increased, and working efficiency of the battery pack can be increased.

During use of the battery pack in the present disclosure, the plurality of electrochemical cells 3 generate heat during working. The heat is transferred to the second heat conduction body 212 through the first heat conduction body 211 that comes into heat conduction contact with the first side surface of the electrochemical cell 3. Then, the second heat conduction body 212 transfers the heat to the heat dissipation plate 11 on the housing 1 through heat conduction contact. Finally, a heat exchange is performed with external air by using the heat dissipation plate 11, to complete heat dissipation. In addition, when the drone needs to be started up and charged at a low temperature, the heating member 4 may further be started up to heat the electrochemical cell 3, to prevent a low-temperature environment from affecting startup of the drone and from affecting charging efficiency. Based on the battery pack in the present disclosure, the heat dissipation assembly 2 is disposed between the electrochemical cells 3, so that the heat generated by the electrochemical cell can be transferred to the heat dissipation plate 11 on the housing 1 of the battery pack through the first heat conduction body 211 and the second heat conduction body 212 that are in the heat conduction member 21, and is then rapidly dissipated by using a temperature difference between the external environment and the housing 1, thereby avoiding final impact that is on use efficiency of the battery pack and a subsequent charging effect and that is caused by accumulation of the heat generated by the electrochemical cell 3 inside the battery pack.

According to a second aspect of the present disclosure, a drone is further provided. The drone includes the battery pack described in the foregoing embodiments, so that during flight of the drone, heat generated by the battery pack can be dissipated in time. For a specific heat dissipation process, refer to the descriptions in the foregoing embodiments. No further details are provided herein again. Moreover, when the drone needs to be started up at a low temperature, the battery pack may further be heated by using a heating member 4, to ensure that the drone can be successfully started up at the low temperature.

The preferred implementations of the present disclosure are described in detail above with reference to the accompanying drawings. However, the present disclosure is not limited to the specific details in the above implementations. Within the technical concept of the present disclosure, a plurality of simple modifications can be made to the technical solutions of the present disclosure, and the simple modifications all fall within the protection scope of the present disclosure.

It should be additionally noted that the various specific technical features described in the above specific implementations can be combined in any suitable manner without contradiction. To avoid unnecessary repetition, various possible combinations are not further described in the present disclosure.

In addition, different implementations of the present disclosure may alternatively be arbitrarily combined without departing from the idea of the present disclosure, and these combinations shall still be regarded as content disclosed in the present disclosure.

1. A battery pack, comprising:
a housing;
an electrochemical cell, the electrochemical cell being disposed inside the housing and a plurality of electrochemical cells being disposed along a first direction; and each of the electrochemical cells having a first side surface and a second side surface that are adjacent to each other, and the first side surface being disposed perpendicular to the first direction; and
a heat dissipation assembly, the heat dissipation assembly comprising a heat conduction member, the heat conduction member comprising a first heat conduction body and a second heat conduction body, the first heat conduction body being disposed between adjacent electrochemical cells and separately coming into heat conduction contact with the first side surfaces of the two adjacent electrochemical cells, the second heat conduction body being disposed at an angle to the first heat conduction body, and the first heat conduction body and the second heat conduction body extending along the second side surface, and coming into heat conduction contact with the housing.

2. The battery pack according to claim 1, wherein the heat conduction member comprises at least a pair of the first heat conduction body and the second heat conduction body that are adjacent to each other; and a plurality of heat conduction members are disposed along the first direction, each of the heat conduction members comprises two first heat conduction bodies and one second heat conduction body connected between the two first heat conduction bodies.

3. The battery pack according to claim 1, wherein the heat conduction member comprises at least a pair of the first heat conduction body and the second heat conduction body that are adjacent to each other; the heat conduction member is single and comprises a plurality of first heat conduction bodies and a plurality of second heat conduction bodies that are alternately disposed along the first direction, and two adjacent second heat conduction bodies are respectively connected on two side edges of a same first heat conduction body.

4. The battery pack according to claim 1, wherein the heat conduction member is of a sheet-like structure, and the sheet-like structure is a graphitic sheet or a graphene sheet.

5. The battery pack according to claim 1, wherein the heat dissipation assembly further comprises a heat conduction pad, the heat conduction pad comprises a first heat conduction pad, the first heat conduction pad is disposed between the second heat conduction body and the second side surface of the electrochemical cell, a plurality of first heat conduction pads are disposed along the first direction.

6. The battery pack according to claim 1, wherein the heat dissipation assembly further comprises a heat conduction pad, the heat conduction pad further comprises a second heat conduction pad, the second heat conduction pad is disposed between the second heat conduction body and the housing, and the second heat conduction pad covers at least two second heat conduction bodies along the first direction.

7. The battery pack according to claim 1, wherein the heat dissipation assembly further comprises a heat conduction pad, the heat conduction pad comprises a first heat conduction pad, the first heat conduction pad is disposed between the second heat conduction body and the second side surface of the electrochemical cell, a plurality of first heat conduction pads are disposed along the first direction, and the heat conduction pad further comprises a second heat conduction pad, the second heat conduction pad is disposed between the second heat conduction body and the housing, and the second heat conduction pad covers at least two second heat conduction bodies along the first direction.

8. The battery pack according to claim 1, wherein the heat dissipation assembly further comprises a heat conduction pad, the heat conduction pad is a graphite foam, the heat conduction pad further comprises a third heat conduction pad, the third heat conduction pad is disposed between the electrochemical cell and the housing.

9. The battery pack according to claim 1, wherein the heat dissipation assembly further comprises a heat conduction pad, the heat conduction pad is a graphite foam, the heat conduction pad further comprises a third heat conduction pad, the third heat conduction pad is disposed between the adjacent electrochemical cells.

10. The battery pack according to claim 1, wherein the battery pack further comprises a heating member, and the heating member is configured to heat the plurality of electrochemical cells.

11. The battery pack according to claim 10, wherein the heating member is constructed as a heating film surrounding the electrochemical cell, an avoidance hole is provided on the heating film, and the avoidance hole is used for exposing the second heat conduction body.

12. The battery pack according to claim 11, wherein the heating member is constructed as an S-shaped heating film that sequentially surrounds the plurality of electrochemical cells, a plurality of heat conduction members are disposed along the first direction, each of the heat conduction members comprises two first heat conduction bodies and one second heat conduction body connected between the two first heat conduction bodies, and a plurality of avoidance holes for exposing the second heat conduction bodies are provided on the heating film.

13. The battery pack according to claim 1, wherein a heat dissipation plate is disposed on a windward side of the housing, the heat dissipation plate is formed by a side wall of the housing or is installed on a side wall of the housing, an inner side of the heat dissipation plate comes into heat conduction contact with the second heat conduction body, and a heat dissipation fin is disposed on an outer side of the heat dissipation plate.

14. A drone, comprising a battery pack,
the battery pack comprising:
a housing;
an electrochemical cell, the electrochemical cell being disposed inside the housing and a plurality of electrochemical cells being disposed along a first direction; and each of the electrochemical cells having a first side surface and a second side surface that are adjacent to each other, and the first side surface being disposed perpendicular to the first direction; and
a heat dissipation assembly, the heat dissipation assembly comprising a heat conduction member, the heat conduction member comprising a first heat conduction body and a second heat conduction body, the first heat conduction body being disposed between adjacent electrochemical cells and separately coming into heat conduction contact with the first side surfaces of the two adjacent electrochemical cells, the second heat conduction body being disposed at an angle to the first heat conduction body, and the first heat conduction body and the second heat conduction body extending along the second side surface, and coming into heat conduction contact with the housing.

15. The drone according to claim 14, wherein the heat conduction member comprises at least a pair of the first heat conduction body and the second heat conduction body that are adjacent to each other; and a plurality of heat conduction members are disposed along the first direction, each of the heat conduction members comprises two first heat conduction bodies and one second heat conduction body connected between the two first heat conduction bodies.

16. The drone according to claim 14, wherein the heat conduction member comprises at least a pair of the first heat conduction body and the second heat conduction body that are adjacent to each other; the heat conduction member is single and comprises a plurality of first heat conduction bodies and a plurality of second heat conduction bodies that are alternately disposed along the first direction, and two adjacent second heat conduction bodies are respectively connected on two side edges of a same first heat conduction body.

17. The drone according to claim 14, wherein the heat dissipation assembly further comprises a heat conduction pad, the heat conduction pad comprises a first heat conduction pad, the first heat conduction pad is disposed between the second heat conduction body and the second side surface of the electrochemical cell, a plurality of first heat conduction pads are disposed along the first direction.

18. The drone according to claim 14, wherein the heat dissipation assembly further comprises a heat conduction pad, the heat conduction pad further comprises a second heat conduction pad, the second heat conduction pad is disposed between the second heat conduction body and the housing, and the second heat conduction pad covers at least two second heat conduction bodies along the first direction.

19. The drone according to claim 14, wherein the battery pack further comprises a heating member, and the heating member is configured to heat the plurality of electrochemical cells.

20. The drone according to claim 14, wherein a heat dissipation plate is disposed on a windward side of the housing, the heat dissipation plate is formed by a side wall of the housing or is installed on a side wall of the housing, an inner side of the heat dissipation plate comes into heat conduction contact with the second heat conduction body, and a heat dissipation fin is disposed on an outer side of the heat dissipation plate.
